(19) United States
(12) Patent Application Publication
(10) Pub. No.: US 2015/0054651 A1
(43) Pub. Date: Feb. 26, 2015

(54) Infusion Module with Audio Output Varying Based on Ambient Sounds

(71) Applicant: CareFusion 303, Inc., San Diego, CA (US)

(72) Inventors: Donald Halbert, San Diego, CA (US); Gregory Borges, San Diego, CA (US); Stephen Bollish, San Diego, CA (US)

(73) Assignee: CAREFUSION 303, INC., San Diego, CA (US)

(21) Appl. No.: 13/971,675

(22) Filed: Aug. 20, 2013

(51) Int. Cl. G08B 3/10; G08B 21/18

(52) U.S. Cl. CPC G08B 3/10; G08B 21/182
USPC 340/692

(57) ABSTRACT

Systems and methods are adapted for ensuring that the sound level of an audible signal, or audio alert, generated by a bedside medical device is appropriate to a hospital environment in which the device is operating. The disclosed systems and methods increase the likelihood that a device annunciates alerts at an audio level that is perceivable by a clinician while minimizing the nuisance to the patient.

### BACKGROUND

A hospital patient often has the need for multiple intravenous (IV) infusions via one or more electronic infusion devices. Upon the occurrence of multiple conditions, including alarm conditions like occlusion of an infusion line, the infusion devices may generate visual and/or audio signal to a bedside caregiver. The audible and visual notification to the caregiver is designed to signal to the user that some sort of action is required or that a condition of the device has changed. The audio signals naturally should be sufficiently loud to attract attention from the bedside caregiver.

While it is desirable for the audio signal to be sufficiently loud so as to attract attention from the appropriate person, an audio signal that is too loud can also be a nuisance to a patient or clinician. This can be especially true in environments such as a neonatal unit where loud sounds can be potentially harmful to a patient.

In view of the foregoing, there is a need for medical infusion systems and methods that adjust audio signals based on the environment where the audio signal is being generated.

### SUMMARY

Disclosed herein are systems and methods for ensuring that the sound level of an audible signal, or audio alert, generated by a bedside medical device is appropriate to a hospital environment in which the device is operating. The disclosed systems and methods increase the likelihood that a device annunciates alerts at an audio level that is perceivable by a clinician while minimizing the nuisance to the patient. In an embodiment, the system utilizes a built-in microphone to determine the ambient sound pressure and references a care area specific audio gain value to determine the appropriate dynamic alert/alarm sound pressure. The audio level can escalate if the generated alarm receives no user response within a specified period of time.

In one aspect, there is disclosed A method for generating an audio signal for a medical device, comprising: detecting the presence of a condition related to the medical device that requires emission of an audio signal; generating an audio signal indicative of the condition, wherein a sound level of the audio signal is at least partially based on an ambient condition.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

FIG. 1 is a front view of a patient care system having four modular fluid infusion pumps, each of which is connected to a respective fluid supply for pumping the contents of the fluid supply to a patient;

FIG. 2 shows a schematic representation of an infusion pump that includes an audio speaker.

FIG. 3 is a flow diagram that shows exemplary steps of a method of adjusting audio output of an audio signal.

FIG. 4 is an enlarged view of a portion of the patient care system of FIG. 1 showing two of the fluid infusion pumps mounted at either side of a programming module, and the displays and control keys of each, with the programming module being capable of programming both infusion pumps;

FIG. 5 is a perspective view of one of the fluid infusion with its front door in the open state;

Like reference symbols in the various drawings indicate like elements.

### DETAILED DESCRIPTION

Disclosed herein are systems and methods for ensuring that the sound level of an audible alert generated by a bedside medical device is appropriate to a hospital environment in which the device is operating. The disclosed systems and methods increase the likelihood that a device annunciates alerts at an audio level that is perceivable by a clinician while minimizing the nuisance to the patient. In an embodiment, the system utilizes a built-in microphone to determine the ambient sound pressure and references a care area specific audio gain value to determine the appropriate dynamic alert/alarm sound pressure. The audio level can escalate if the generated alarm receives no user response within a specified period of time.

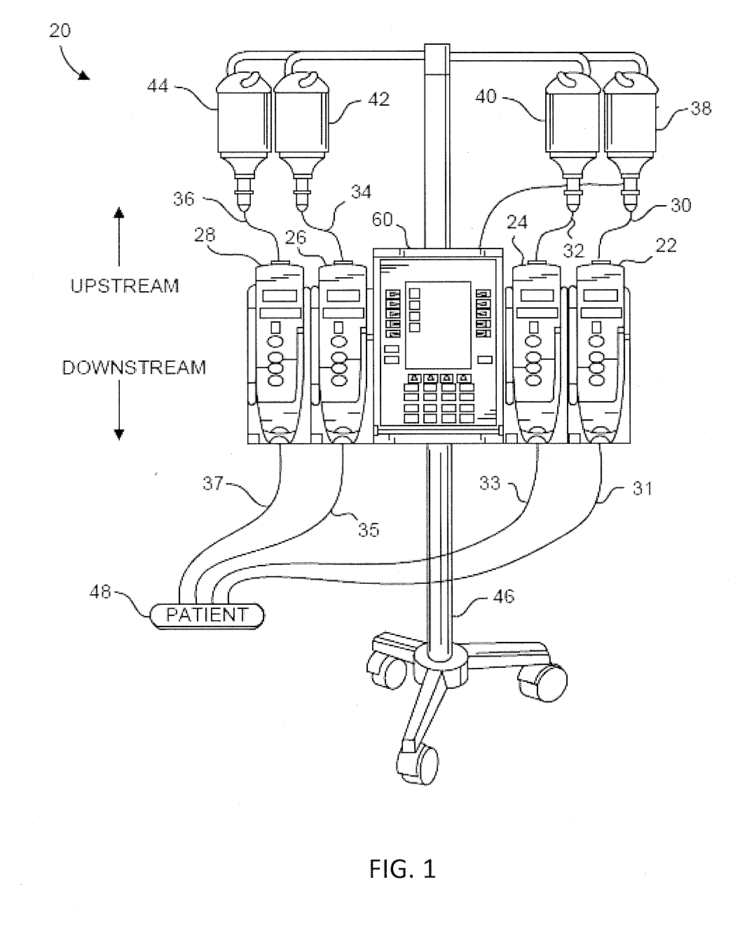

The disclosed system can be used with any of a variety of patient medical device systems that are configured to generate an audio notification (also referred to as an audio signal), such as an infusion pump system. An example modular infusion pump system is shown with reference to FIG. 1, which shows a patient care system 20 having four infusion pumps 22, 24, 26, and 28. It should be appreciated that the system 20 shown in FIG. 1 is an example and that the audio notification system described herein can be used with any of a variety of patient bedside medical devices. One or more of the infusion pumps may include audio equipment in the form of a speaker for generating an audio signal to a user. The audio signal to the user is designed to signal to the user that some sort of action is required or that a condition of the device has changed. For example, the device(s) may issue an audio signal on occurrence of an alarm condition or when a button on the device is pressed. Any of a variety of conditions may trigger emission of an audio signal.

With reference to FIG. 1, a programming module 60 is attached to infusion pumps 26 and 24. In this regard, each of the infusion pumps 22, 24, 26, and 28, as well as the programming module 60, includes at least one connector element configured to mechanically and communicatively connect to a connector element of another infusion pump or programming module. The mechanical element may be any type of mechanical connection that is configured to connect a modular infusion pump to another modular infusion pump or programming module.

It should be appreciated that the relative positions and orientation of the pumps relative to one another and to the programming module may vary.

With reference still to FIG. 1, each of the infusion pumps 22, 24, 26, and 28 is fluidly connected with an upstream fluid line 30, 32, 34, and 36, respectively. Each of the four infusion pumps 22, 24, 26, and 28 is also fluidly connected with a downstream fluid line 31, 33, 35, and 37, respectively. The fluid lines can be any type of fluid conduit, such as tubing, through which fluid can flow through. Fluid supplies 38, 40, 42, and 44, which may take various forms but in this case are shown as bottles, are inverted and suspended above the pumps. Fluid supplies may also take the form of bags or other types of containers. Both the patient care system 20 and the fluid supplies 38, 40, 42, and 44 are mounted to a roller stand or IV pole 46.

A separate infusion pump 22, 24, 26, and 28 is used to infuse each of the fluids of the fluid supplies into the patient. The infusion pumps are flow control devices that will act on the respective fluid line to move the fluid from the fluid supply through the fluid line to the patient 48. Because individual pumps are used, each can be individually set to the pumping or operating parameters required for infusing the particular medical fluid from the respective fluid supply into the patient at the particular rate prescribed for that fluid by the physician. Such medical fluids may comprise drugs or nutrients or other.

Typically, medical fluid administration sets have more parts than are shown in FIG. 1. Many have check valves, drip chambers, valved ports, connectors, clamps and other devices well known to those skilled in the art. These other devices have not been included in the drawings so as to preserve clarity of illustration.

### Generation of Audio Signals

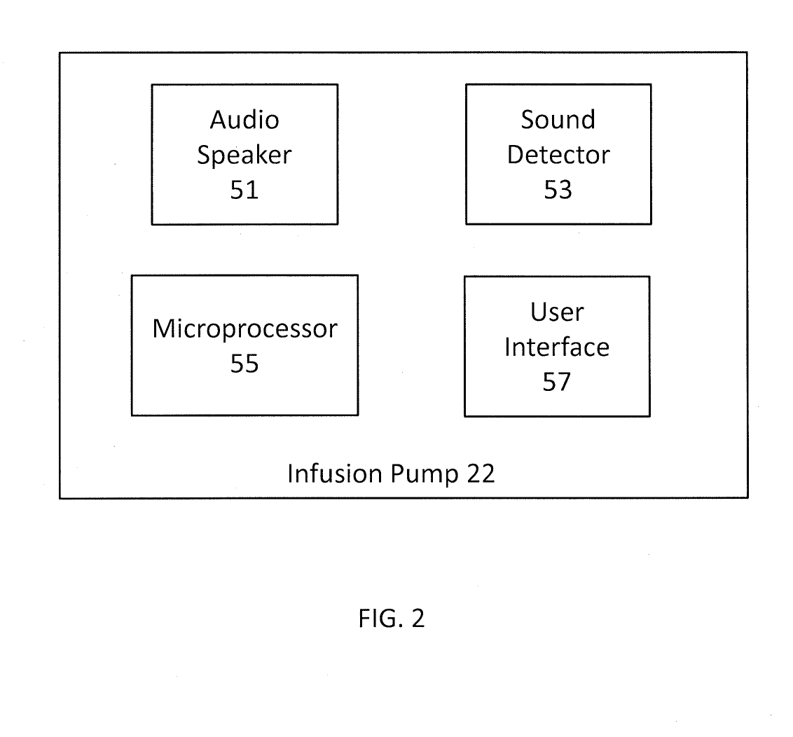

As mentioned, one or more of the infusion pumps includes at least one speaker for outputting an audio signal. In an embodiment, there is one main speaker that generates audio signals on behalf of all the pumps. FIG. 2 shows a schematic representation of an infusion pump 22 that includes an audio speaker 51. The infusion pump 22 also includes a sound detector 53 that is configured to detect a level of ambient sound. The sound detector 53 may be any device that is configured to detect sound or detect an ambient characteristic of sound level, such as pressure. Any of a variety of sound detection methods or devices may be used. The sound detector 53 and speaker 51 are both coupled to at least one microprocessor 55 that has access to software for analyzing and responding to a detected level of sound and for causing the speaker to emit an audio signal. The infusion pump may also include a user interface 57 that permits a user to interact with the infusion pump with respect to alarm conditions.

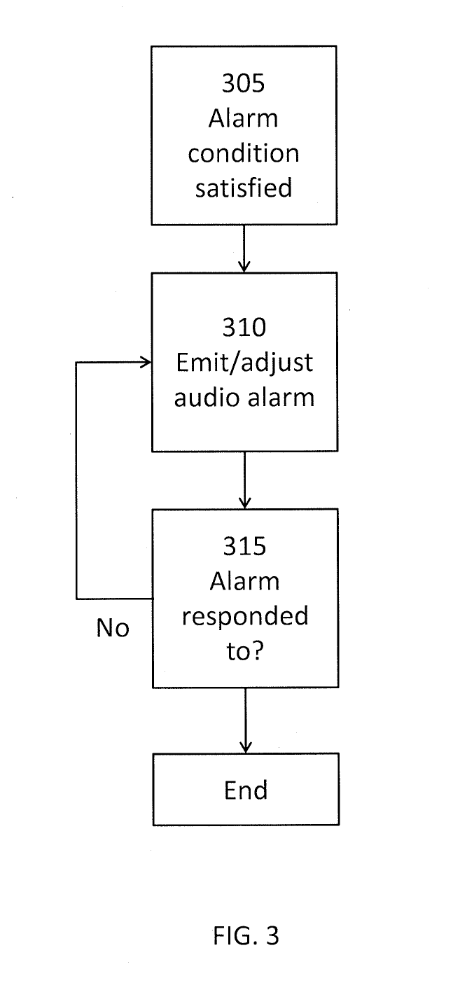

There is now described an exemplary method for generating an audio indication based upon the occurrence of a condition or action. As mentioned, an audio signal may be generated upon occurrence of a variety of conditions or actions, such as when a button is pressed or when an alarm condition is satisfied. The method is defined in the context of generating an audio signal when an alarm condition is satisfied. However, it should be appreciated that the method can apply to generation of any audio signal and is not limited to generation of audio signals associated with an alarm condition. FIG. 3 is a flow diagram that shows exemplary steps of the method. In a first step 305, an alarm condition is satisfied such that the system is required to emit an audio signal. The alarm condition can vary and can include any type of alarm condition that can exist in a patient environment. For example, the alarm condition can be that an occlusion was detected in a fluid line to the patient.

In a next step 310, the speaker emits an audio signal with a sound level of the audio signal at least partially based on ambient conditions. That is, the sound level of the audio signal is at least partially based on the environment in which the infusion pump and/or the patient are located. In an embodiment, the environmental conditions are determined and detected in real time. For example, the sound level of the audio signal may be based at least partially on a detected level of ambient sounds wherein the speaker generates a louder audio signal if the detected level of ambient sound is above a threshold. Or the speaker may generate a less loud audio signal if the detected level of ambient sound is below a threshold.

The microprocessor may have access to library data that at least partially governs a permissible or desired level of sound for the audio signal. For example, if the infusion pump is located in a neonatal environment, the library data may provide an upper limit on the level of sound (at least for an initial audio signal) that is configured to not disturb or incur a nuisance to patients. In a neonatal environment, the patients may be disturbed or even harmed by a level of sound that is too loud. The library data may also govern a minimum level of sound for an audio signal, wherein the minimum is the lowest level of sound that may be reasonably heard by a clinician. The library data may also include an audio gain that is specific to the type of environment where the infusion pump is located. The audio gain determines the appropriate audio signal to be emitted based on the detected ambient conditions.

In a next step 315, the system determines whether or not a clinician has responded to the audio signal. For example, the system may determine whether the clinician has corrected the condition that caused the audio signal or whether the clinician has turned off the audio signal. If the clinician has not responded to the audio signal (such as within a predetermined passage of time), then the process returns to step 310. As discussed above, at step 310 the system may then adjust the sound level of the audio signal such as to raise the sound level or to vary the sound pattern of the audio signal. If the clinician has sufficiently responded to the audio signal, then the process ends.

### Exemplary Configuration of Modules

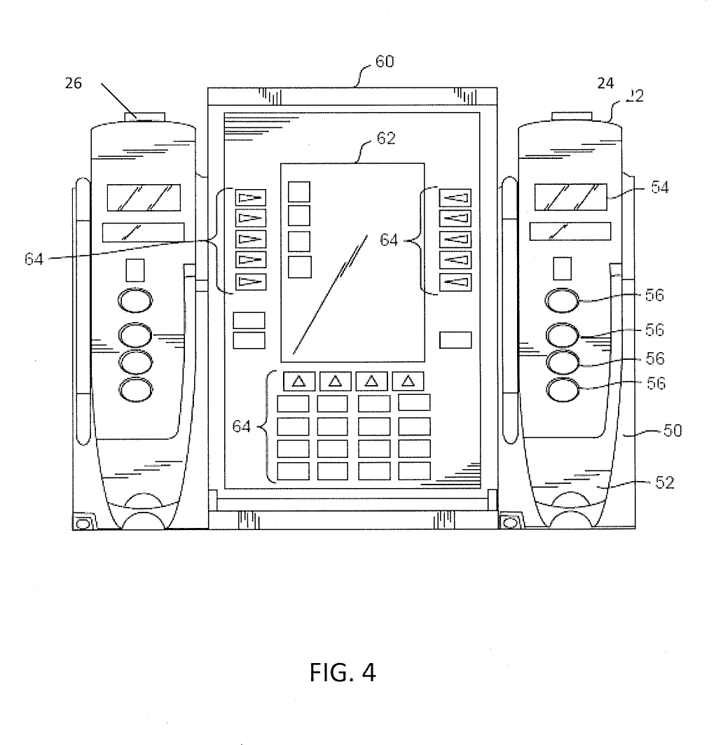

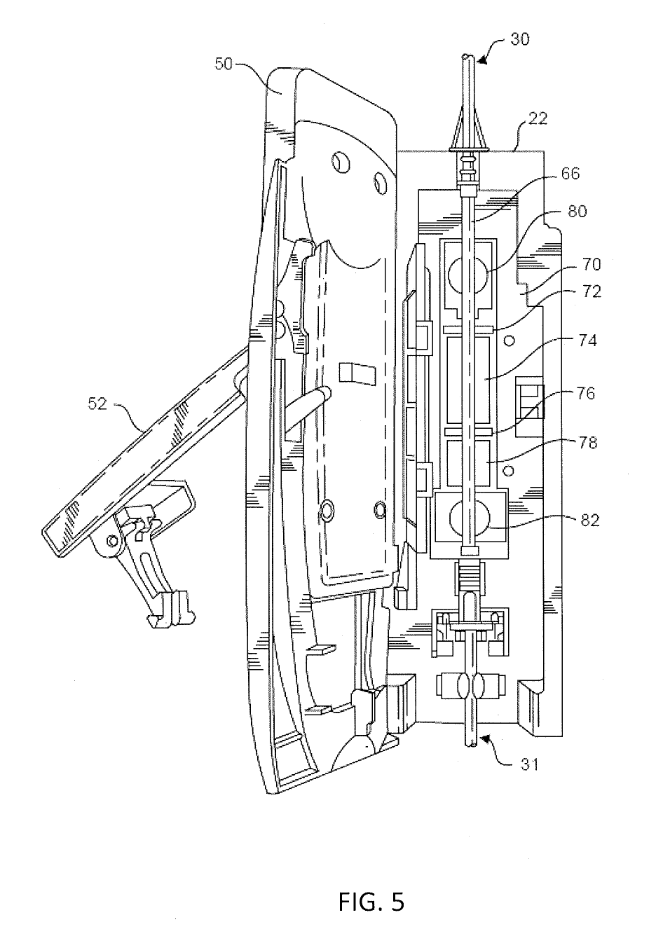

Referring now to FIG. 4, an enlarged view of the front of the infusion pumps 24 is shown attached to the programming module 60. The pump includes a front door 50 and a handle 52 that operates to lock the door in a closed position for operation and to unlock and open the door for access to the internal pumping and sensing mechanisms and to load administration pump sets or pump cassettes for the pump. When the door is open, a tube of the pump set can be connected with the pump, as will be shown in FIG. 5. When the door is closed, the tube is brought into operating engagement with the pumping mechanism, the upstream and downstream pressure sensors, and the other equipment of the pump. A display 54, such as an LED display, is located in plain view on the door in this embodiment and may be used to visually communicate various information relevant to the pump, such as alert indications (e.g., alarm messages). Control keys 56 exist for programming and controlling operations of the infusion pump as desired. As mentioned, the infusion pump 24 also includes audio alarm equipment in the form of a speaker.

Other devices or modules, including another infusion pump, may be attached to the right side of the infusion pump 24, as shown in FIG. 1. In such a system, each attached pump represents a pump channel of the overall patient care system 20. In one embodiment, the programming module is used to provide an interface between the infusion pump 24 and external devices as well as to provide most of the operator interface for the infusion pump 24.

With reference still to FIG. 4, the programming module 60 includes a display 62 for visually communicating various information, such as the operating parameters of the pump 24 and alert indications and audio alarm messages. The programming module 60 may also include a speaker to provide audible alarms. The programming module also has various input devices in this embodiment, including control keys 64 and a bar code scanner (not shown) for scanning information relating to the infusion, the patient, the care giver, or other. The programming module also has a communications system (not shown) with which it may communicate with external equipment such as a medical facility server or other computer and with a portable processor, such as a handheld portable digital assistant (“PDA), or a laptop-type of computer, or other information device that a care giver may have to transfer information as well as to download drug libraries to a programming module or pump.

The communications system may take the form of a radio frequency (“RF”) (radio frequency) system, an optical system such as infrared, a Blue Tooth system, or other wired or wireless system. The bar code scanner and communications system may alternatively be included integrally with the infusion pump 24, such as in cases where a programming module is not used, or in addition to one with the programming module. Further, information input devices need not be hard-wired to medical instruments, information may be transferred through a wireless connection as well.

FIG. 4 shows a second pump module 26 connected to the programming module 60. As shown in FIG. 1, more pump modules may be connected. Additionally, other types of modules may be connected to the pump modules or to the programming module.

Turning now to FIG. 5, an infusion pump 22 is shown in perspective view with the front door 50 open, showing the upstream fluid line 30 and downstream fluid line 31 in operative engagement with the pump 22. The infusion pump 22 directly acts on a tube 66 that connects the upstream fluid line 30 to the downstream fluid line 31 to form a continuous fluid conduit, extending from the respective fluid supply 38 (FIG. 1) to the patient 48, through which fluid is acted upon by the pump to move fluid downstream to the patient. Specifically, a pumping mechanism 70 acts as the flow control device of the pump to move fluid though the conduit.

The type of pumping mechanism may vary and may be for example, a multiple finger pumping mechanism. For example, the pumping mechanism may be of the “four finger” type and includes an upstream occluding finger 72, a primary pumping finger 74, a downstream occluding finger 76, and a secondary pumping finger 78. The “four finger” pumping mechanism and mechanisms used in other linear peristaltic pumps operate by sequentially pressing on a segment of the fluid conduit by means of the cam-following pumping fingers and valve fingers 72, 74, 76, and 78. The pressure is applied in sequential locations of the conduit, beginning at the upstream end of the pumping mechanism and working toward the downstream end. At least one finger is always pressing hard enough to occlude the conduit. As a practical matter, one finger does not retract from occluding the tubing until the next one in sequence has already occluded the tubing; thus at no time is there a direct fluid path from the fluid supply to the patient. The operation of peristaltic pumps including four finger pumps is well known to those skilled in the art and no further operational details are provided here.

In this particular embodiment, FIG. 5 further shows a downstream pressure sensor 82 included in the pump 22 embodiment at a downstream location with respect to the pumping mechanism. The downstream pressure sensor 82 is mounted to the flow control device 70 and is located adjacent and downstream in relation to the flow control device. The downstream pressure sensor is located downstream from the flow control device, that is, at a location between the patient 48 (FIG. 1) and the flow control device, so that the connection of the correct fluid supply with the correct pump may be verified before any fluid is pumped to the patient.

With reference still to FIG. 5, an upstream pressure sensor 80 may also be included in the pump 22. The upstream pressure sensor is assigned to the flow control device or pumping mechanism 70 and, in this embodiment, is further provided as an integral part of the pump 22. It is mounted to the flow control device 70 and is located adjacent and upstream in relation to the flow control device. The upstream pressure sensor is located upstream from the flow control device, that is, at a location between the fluid supply 38 (FIG. 1) and the flow control device, so that the connection of the correct fluid supply with the correct pump may be verified before any fluid is pumped to the patient.

One or more aspects or features of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device (e.g., mouse, touch screen, etc.), and at least one output device.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow(s) when depicted in the accompanying figures and/or described herein do not necessarily require the particular order shown, or sequential order, to achieve desirable results. Other implementations may be within the scope of the following claims.

1. A method for generating an audio signal for a medical device, comprising:
detecting the presence of a condition related to the medical device that requires emission of an audio signal;
generating an audio signal indicative of the condition, wherein a sound level of the audio signal is at least partially based on an ambient condition.

2. A method for generating an audio signal as in claim 1, further comprising detecting a level of ambient sounds in real time.

3. A method as in claim 1, wherein the condition is an alarm condition.

4. A method for generating an audio signal as in claim 3, further comprising determining whether the audio signal has been responded to.

5. A method for generating an audio signal as in claim 3, further comprising adjusting the sound level if the alarm condition has not been responded to.

6. A method for generating an audio signal as in claim 1, further comprising setting a maximum initial sound level of the audio signal.

7. A method for generating an audio signal as in claim 1, wherein the ambient condition relates to a neonatal hospital unit.

8. A method for generating an audio signal as in claim 2, wherein the sound level is based on the detected level of ambient sound.

9. A method for generating an audio signal as in claim 8, wherein the sound level is higher based on a higher detected level of ambient sound.

10. A method for generating an audio signal as in claim 1, further comprising generating a louder audio signal if the detected level of ambient sound is above a threshold

11. A method for generating an audio signal as in claim 1, further comprising generating a less loud audio signal if the detected level of ambient sound is below a threshold.

12. A method for generating an audio signal as in claim 1, wherein the ambient condition is a type of hospital unit.

13. A method for generating an audio signal as in claim 1, wherein the ambient condition is current ambient sound.

14. A method for generating an audio signal as in claim 1, wherein the ambient condition is predicted ambient sound.

15. A method for generating an audio signal as in claim 1, wherein the medical device is an infusion pump.
